(19) United States
(12) Patent Application Publication
(10) Pub. No.: US 2026/0140094 A1
(43) Pub. Date: May 21, 2026

(54) PUMPLESS SYSTEM FOR GRADIENT BUFFER PRODUCTION

(71) Applicant: Equilibar, LLC, Fletcher, NC (US)

(72) Inventors: Ryan Matthew Heffner, Fletcher, NC (US); Jennifer Marie Jacober, Fletcher, NC (US); Jeffrey Dean Jennings, Fletcher, NC (US); Carlyle Leonard Donevant IV, Fletcher, NC (US); Robert Paul Hendrix-Ojeda, Midvale, UT (US)

(21) Appl. No.: 19/121,964

(22) PCT Filed: Oct. 18, 2023
(86) PCT No.: PCT/US2023/077143

§ 371 Date: Apr. 17, 2025

Related U.S. Application Data
(60) Provisional application No. 63/417,317, filed on Oct. 18, 2022.

(51) Int. Cl. G01N 30/34; G01N 30/32

(52) U.S. Cl. CPC G01N 30/34; G01N 30/32; G01N 2030/324; G01N 2030/347

(57) ABSTRACT

An apparatus for gradient elution is disclosed. The apparatus includes two or more liquid flowpaths connected at a mixing point, at least one of the two or more liquid flowpaths including: a source configured to supply a pressurized liquid; a closed-loop flow control apparatus including a dome-loaded diaphragm valve, a flow transducer, and an electronic flow controller operably coupled to the flow transducer and the dome-loaded diaphragm valve; a sensor configured to detect a liquid composition downstream of the mixing point; and an electronic master controller coupled to the sensor and to the closed-loop flow control apparatus.

### CROSS-REFERENCE TO RELATED APPLICATIONS

This application claims the benefit of provisional patent application 63/417,317 filed Oct. 18, 2022, which is incorporated by reference herein.

### BACKGROUND OF THE INVENTION

The present invention relates to a pumpless system, and more particularly to a pumpless system for gradient buffer production.

In gradient elution chromatography, there is a need for a continuously varying concentration of various buffers and solvents to control the release of eluants. However, the overall surface area taken by buffer storage and delivery to chromatography systems used within the pharmaceutical industry can result in very large incurred clean room costs over the lifetime of the manufacturing facility, as well as, drive incurred operational and capacity inefficiencies in batch scheduling, the production and storage of these buffers, the movement of large buffer volumes, and the safety and additional capital equipment costs associated with movement and storage of buffer solutions.

Dilution of buffers from a high concentrated starting medium has long been an established solution for minimizing starting buffer solution surface area within the manufacturing facility. However, current buffer starting concentration and dilution to achieve desired final concentrations are currently limited within single use biopharmaceutical manufacturing processes due to the available turn down ratio and subsequent control ranges of the present commercially available equipment. FIG. 1 demonstrates the dilution capability of present-day manufacturing solutions (elongated shaded area along y-axis) versus the saturation limit at room temperature of a variety of common salt buffers (shaded area along x-axis). FIG. 1 further demonstrates the theoretical costs savings to manufacturing if a novel device were able to allow pharmaceutical manufactures to start gradient chromatography processes with inline dilution of salt buffers at room temperature saturation limits. Such a device would drastically converge manufacturing costs irrespective of manufacturing scale between 500 L and 5000 L manufacturing processes.

Typically, buffer or solvent concentrates are metered through variable speed positive displacement pumps, such as diaphragm pumps or peristaltic pumps. In high precision systems, many vendors have upgraded these systems to include flow meters with closed-loop feedback control on the pump speed (variable speed frequency control) to ensure accurate dosing of each fluid component to constitute the gradient elution profile. The mixed stream is monitored by a sensor((typically pH or conductivity) to ensure conformance to the desired fluid concentrations. Product that does not conform to the desired control value is sent to a dump valve, drain valve, or bypass line, which goes to waste, since it cannot be used after mixing if it's not the desired profile.

Positive displacement pumps augmented with expensive flow meters and variable frequency controllers adds up to significant inefficiency in the capital equipment. For single use systems, expendable flow meters and pumps are expected to add up to several thousands of dollars per fluid control point per batch. Further, stair step-like metering/mixing of these solutions could pose limited turndown capabilities and prevent gradient systems from being as resolute as drug makers would like.

An additional issue of positive displacement pumps is that of pulsations, both pressure and flow pulsations. While the buffer/solvent solutions are not shear sensitive themselves, the chromatography columns are demonstrated to be highly sensitive to flow variations or pulsations in the pressure or flow profiles. Pulsations also can affect mixing efficiency and cause the buffer to be non-conformant. The pH or conductivity perspectives and flow meter feedback disturbs the master control loop which limits precision.

It is a known issue that single use versions of positive displacement pumps also suffer from flow repeatability for a variety of reasons. First, the disposable material used presents minor manufacturing variations that result in slightly different flow vs. RPM profiles. Also, as pressure and time wear the disposable materials, this flow vs. RPM profile changes the dosed flow. Finally, environmental conditions like varying suction pressure can change the flow profile through the pump. In most cases, even minor suction pressures >0 psig can cause “push through flow”, which limits the low flow capabilities of these pumps, rendering some buffer mixing profiles unachievable. All of these variables then require the use of the flow meter for PID feedback to stabilize the real measured flow in the system to the setpoint to achieve the gradient elution chemistry required. This dependence on an external PID and time and material dependent variations limit precision and overall conductivity/pH profiles achievable by traditional systems, which can impact overall process effectiveness, particularly for sensitive modalities like those found in the cell and gene therapy space.

Water for injection (WFI—highly purified water adhering to the requirements of the United States Pharmacopeia (USP)) is typically metered through a control valve or a metering pump as described for the concentrates. In some systems, a control valve is also used for the buffer or solvent concentrates. Typical pharmaceutical control valves may have a turndown of 10:1 w/w %, which requires either multiple control valves in parallel, or the use of another pump to meter WFI for mixing. If a pump is used, it would also involve the use of a pressure reducing valve (PRV) to step WFI header pressure down to appropriate net positive suction head (NPSH) levels. In single use systems, the dearth of available options for control valves has led to the use of mechanical pinch valves for flow rate control of WFI, buffers/solvents, or both.

The limitation of flow rate turndown of both systems described above is a significant constraint on the design of efficient gradient elution processes. Typical pump turndown ratios are in the range of 10:1, with highly adapted systems capable of going to 20:1 or 30:1. Similarly, control valves are typically capable of flow rate turndown ranges of 15:1 to 30:1, with some models performing at 50:1. However, in the single use biopharma systems, the crude mechanical pinch valves are typically not capable of greater than 20:1 or 30:1 due to the significant limitations of the mechanism hysteresis and resolution. In some cases, single use diaphragm valves can act like a type of pinch valve, changing the open area to result in a similar behavior and similar crude and imprecise performance. Peristaltic pumps can be used for accurate metering but have short and long term issues that are present when considering them for gradient systems (specifically nonlinearity at the top and bottom of the pumping range which then limits the true range of linearity within the system).

Additionally, the limited turn down ratio of existing systems is not conducive to producing economically efficient processes at scale with typical application parameters.

In an ideal system, solvents and buffers of logarithmically defined concentrations would be produced from solvent and buffer concentrates blended with WFI. These concentrations would allow for concentrates to be blended with water in ranges as broad as 1000:1 w/w % profiles and for the gradient of said concentrations to be linearly or nonlinearly varied, according to a defined concentration/time profile necessary to achieve ideal separation for the molecule of interest within a bind and elute chromatographic system.

Accordingly, there is a need for a pumpless system for gradient buffer production that overcomes the limitations of the methods described above.

### BRIEF SUMMARY OF THE INVENTION

This need is addressed by a system for preparing gradient buffers that provides the following:
a flow rate turn down significantly greater than 50:1 or even 100:1;
continuously variable concentrations across ranges up to beyond 100:1 with no step changes or disruption;
feedback control from a sensor measuring variables such as pH, conductivity, or other similar ionic concentration sensors;
avoids duplicative investment of a metering pump with flow meter and variable frequency drive;
avoids pulsations in the pressure and flow profiles;
quickly gets to mixing setpoint to reduce the wasted buffer non-conformant to the gradient need;
chemical compatibility with the high concentrations of solvents required to produce the varied buffer profiles; and
to take high molarity buffers and dilute at extreme ratios. The best system will take high molarity buffers (e.g. 10M NaCl) and dilute in a very wide range. This can avoid floor space constraints that lower turndown systems suffer from, which improves the overall plant effectiveness/sq ft.

According to one aspect of the technology described herein, an apparatus for gradient elution includes two or more liquid flowpaths connected at a mixing point, at least one of the two or more liquid flowpaths including: a source configured to supply a pressurized liquid; a closed-loop flow control apparatus including a dome-loaded diaphragm valve, a flow transducer, and an electronic flow controller operably coupled to the flow transducer and the dome-loaded diaphragm valve; a sensor configured to detect a liquid composition downstream of the mixing point; and an electronic master controller coupled to the sensor and to the closed-loop flow control apparatus.

According to another aspect of the technology described herein, a pumpless method for gradient elution includes providing two or more flowpaths connected at a mixing point; for each of the two or more flowpaths, flowing a liquid component down the flowpath by: pressurizing the liquid component; metering a flow rate of the liquid component using a closed-loop flow control apparatus including a dome-loaded diaphragm valve, a flow transducer, and an electronic flow controller operably coupled to the flow transducer and the dome-loaded diaphragm valve; combining the liquid components at the mixing point to form a mixture; using a sensor to evaluate a composition of the mixture; and using an electronic master controller, receiving input from the sensor and independently controlling the closed-loop flow control apparatus of each of the two or more flowpaths so as to vary the composition of the mixture over time.

### BRIEF DESCRIPTION OF THE DRAWINGS

The invention may be best understood by reference to the following description taken in conjunction with the accompanying drawing figures in which:

FIG. 1 is a graph showing purification cost vs. buffer starting concentration;

FIG. 2 illustrates a pumpless system for gradient buffer production according to an embodiment of the invention;

FIG. 3 is a flow diagram of a control scheme for the invention of FIG. 2;

FIG. 4A is a plan view of a gasket with a single truncated cone;

FIG. 4B is a section view of the gasket of FIG. 4A;

FIG. 5 illustrates the truncated cone of the gasket of FIG. 4A interacting with a passthrough channel of a lid of a pressure vessel;

FIG. 6A is a plan view of a gasket having multiple truncated cones;

FIG. 6B is a section view of the gasket of FIG. 6A; and

FIG. 7 is a perspective view of a gasket with a hole extending therethrough.

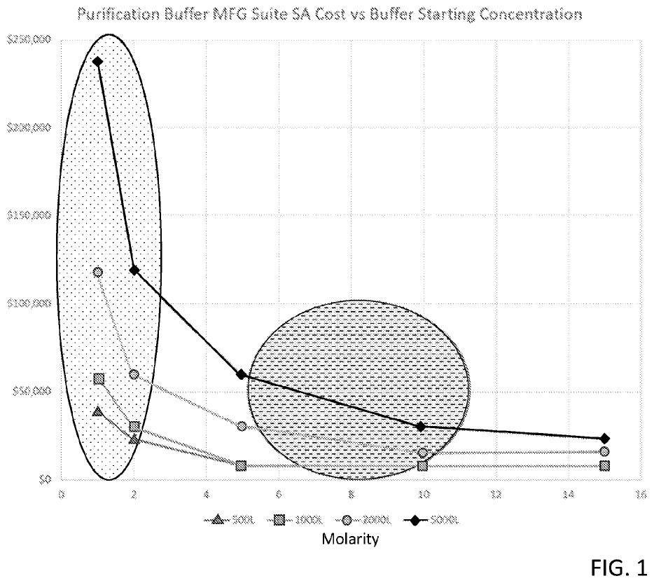

### DETAILED DESCRIPTION OF THE INVENTION

Described herein is a pumpless system capable of producing wider ranges of buffer solution concentrations and varying the concentration of these blended solutions over time. This system provides for more efficient and effective separation in the process of flow through or bind and elute gradient chromatography of biopharmaceutical, advanced specialty therapies (gene therapy, mRNA, cell therapy) and specialty chemical agents through expansion of the control range past what is currently capable in similar systems which rely solely on elution gradients produced through the combination of two pumped liquid streams.

For purposes of this application, the term gradient elution refers to a separation method where the components are distributed between two phases, one of which is stationary, while the other moves in a definite direction (the “mobile” phase). In gradient-elution chromatography, the elution solvent strength of the mobile phase is gradually increased during the separation.

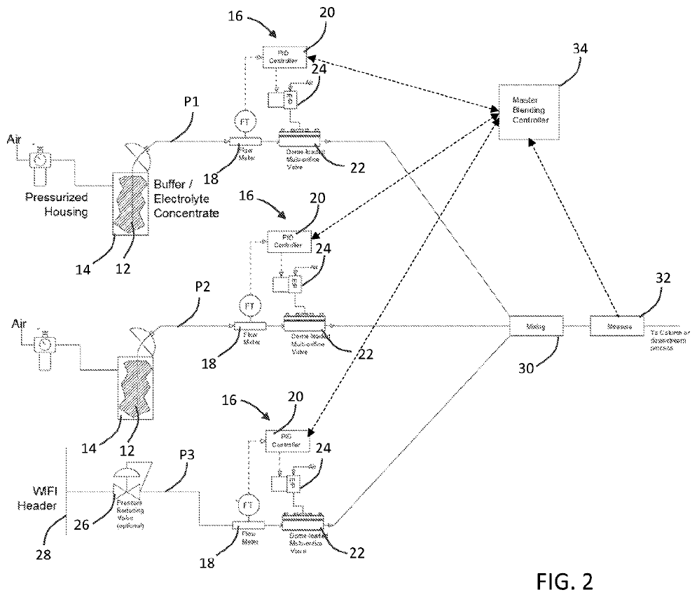

Now, referring to the drawings wherein identical reference numerals denote the same elements throughout the various views, FIG. 2 illustrates an exemplary embodiment of a pumpless system for gradient buffer production 10. The system 10 includes at least two fluids, but commonly up to 6 or more fluids may be included. These fluids can be pressurized by any combination of:
At least one fluid pressurized by an air pressure header:
   through a sterile bag;
   From a Larger Pressurized Vessel;
   directly pressurized by the holding container the vessel exists (for concentrate fluids);
   elevation to achieve the necessary driving pressure, and/or subtract from the needed driving pressure; or
   mechanical compression of a container.
May include one or more fluids from a pressurized delivery header such as WFI header (pumped header).

The system 10 avoids the use of all positive displacement or metering pumps by providing a method of installing flexible aseptic bags 12 of concentrated buffer predecessors into pressurized containers or housings 14, sealing them with minimal disruption, and delivering the fluids through a flow metering system 16 capable of delivering 100:1 and up to 1000:1 flow rate turndown ratio. The flow metering system 16 includes a flow meter 18, a proportional-integral-derivative (PID) controller 20, a dome-loaded direct sealing diaphragm valve 22, and an electronic air pressure regulator 24.

The system may be provided with buffer connections from vessels that can withstand modest pressures. The driving pressure in the system could be of mostly any magnitude, taking into consideration that the driving pressure needs to be sufficiently large to overcome system restrictions to ensure the peak flow rate is achievable. For example, the targeted driving pressure may be at a 1 bar setpoint but may vary depending on system needs for turndown ratios for the desired mixing ratio. This is envisioned to be in the range of about 0.5 to about 1.5 bar(g), but for specific exotic buffers a driving pressure of up to 6 bar driving pressure may be used to ensure appropriate flow for mixing.

Pressurized vessels may be set to, for example, 1 bar(g) to drive flow. If the concentrate vessel allows, the vessel may be directly pressurized to generate driving flow. It's common for these large concentrate vessels to be stored at an elevation to save manufacturing floor space, so the combination of elevation head pressure plus weak driving pressure may constitute the 1 bar of needed driving pressure to achieve the desired mixing profile. Single use systems typically have a peak pressure rating of 4 bar, so this would establish an approximate high-pressure ceiling for pressure driven flow to remain in standard maximum allowable working pressure (MAWP) ratings.

Flow meter 18 is required to provide real-time updates to a closed-loop flow control (PID) controller 20 optionally with custom gain curves loaded, much like a standard gradient system is used for flow feedback. The flow meter 18 response time is in the range of about 10 ms to about 20 ms or faster. The dome-loaded direct sealing diaphragm valve 22 is used to provide high resolution and high rangeability flow control. Non-limiting commercially available valves include the FDO Series for stainless biopharma systems and the SDO Series for single use biopharma systems from Equilibar.

A custom flow controller is provided that includes the electronic air pressure regulator controlled by input current (I/P) or voltage (E/P) signal 24 and also includes a high speed PID loop adapted with value-adding logic such as custom gain curves and other programming for providing highly resolute flow control. An I/P or E/P device is an industry standard electro-pneumatic device that receives an electrical signal to control an incoming air supply to a desired output pressure. This logic is useful to handle disturbance conditions to minimize setpoint deviation to target for limited buffer waste, which is a key metric for reducing system operating cost. In a specific example, said flow control provides for a PID calculation action more than 800 times/second to stabilize the control valve in the extreme ends of the flow ranges required for the 100:1 to 1000:1 flow turndown ranges.

One or more measuring sensors provide feedback control to the flow control loops, such as trimming the flow rate of an acid or base according to pH sensor feedback or trimming the water/solvent according to a conductivity probe. This setpoint is driven by the system process needs for the various steps for chromatography that the gradient system would be utilized for, among other needs.

Additionally, a pressure reducing valve (PRV) 26 may optionally (instead of directly connecting the WFI header to flow metering system 16) be used on a WFI header 28 and may represent a zerostatic valve, which is commonly used to allow flow to a leg stemming from the WFI header 28. Some embodiments of the proposed flow path may choose to skip the PRV altogether and directly control fluid coming from the header for purposes of flow control. This choice will be specific to the process and/or system requirements. One further system feature not shown is a waste line or bypass line, which would exist downstream of the mixer, and would be used to dump non-conformant fluid to drain. This would commonly be an automated process where an on/off valve (typically a diaphragm valve) would open to divert flow to waste. This diaphragm valve may be a 3 way valve or any other suitable valve. Downstream of the measurement device, there would likely be an intermediate holding tank, otherwise known as a buffer tank, to house fluid ready to be sent to the chromatography column. It should be appreciated that the PRV valve could be removed in favor of direct control against WFI header pressure.

Some sensors such as conductivity have slower time response than desired. The following control technique or algorithm can be used to allow both fast control of inferred conductivity (or other variable) while also using a correction factor to eliminate the offset of the steady state readings.

The correction ratios can be calculated using a rolling average technique or PID integral technique in real time. In a preferred implementation, the correction factor is only modified when the system and its setpoints are stable.

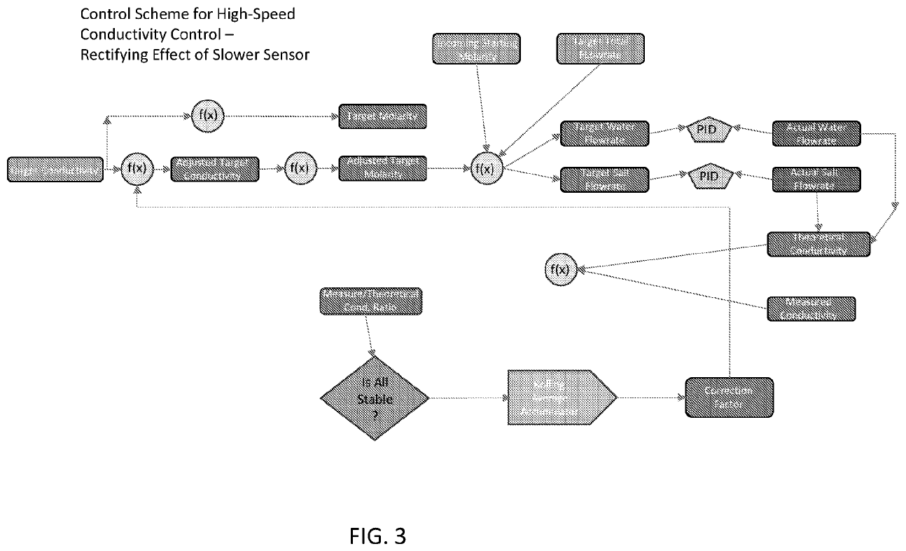

The rolling average technique is illustrated in FIG. 3. The code for this system needs to compute as fast as possible to ensure robust mixing of the streams for the desired gradient profile. The turndown of these valves is quite high for demanding regions on the conductivity curve, so faster code allows for accurate measurement and small compensation to ensure the highest accuracy. Conductivity sensors typically read slowly (typically 1 second is the industry fastest option), so a code is needed to calculate theoretical conductivity, compare to the measured value, and compensate the mixing ratio for real world variations.

These variations may be slight molarity changes from high saturation aqueous solutions, or temperature effects from the process environment changing the solubility of the buffer, influencing molarity.

This code utilizes a feedback loop to check for the following;
calculate conductivity based on theoretical mixing of the two flow streams for calculated conductivity;
use a slower measurement on real conductivity (typically 1 second);
calculate a correction factor to compensate for real world measurements to adjust for molarity or other changes in the immediate buffer; and
ensure error is minimal through a feedback loop.

The user will need to input total flow, which is often referred to as Column Volumes, which is a parameter used for ion exchange chromatography relating to residence time.

Referring back to FIG. 2, flow paths P1, P2, and P3 converge at a mixing point 30 where the WFI and buffer solutions are mixed. The mixed solution is then measured for accuracy by a liquid composition sensor 32. A master blending controller 34 is operably connected to the liquid composition sensor 32 and PID controllers 20 to make necessary adjustments to the flows of the WFI and buffer solutions.

While the system 10 is being discussed with container 14 to ensure pressure is realized around the environment to drive flow, it should be appreciated that gravity could be utilized if the bag 12 could be stored at higher elevations. Typical elevations would need to be sufficient to drive peak flows, which may be in the 15 psi range. This equates to an elevation of ˜30′ above the gradient system to reach this approximate driving pressure. Applications may be limited in the storage area, so the system can be designed/compensated with line size and control valve sizing to accommodate for the available head pressure from buffer storage. If this is done, the code and logistics of the system will compensate for the available pressure through measurement or customer input into the logic.

For single use systems, it is common for bags, tubing, and other components to be preassembled as a kit and sterilized prior to insertion into the system. It is necessary to minimize exposure of the internal wetted pathways of these kits to the external environment to mitigate possible contamination by viable and nonviable particulate matter, even in a clean room environment.

In the example of a system which utilizes sterile bags 12 that deliver flow driven from external pressure captured inside a secondary pressure container 14, a novel sealing method is required to allow the wetted fluid pathway to exit the container 14 while still retaining pneumatic pressure inside the pressure retaining container 14 and to allow the flexible bag 12 to be inserted into the container 14 while maintaining integration with tubing 15 and additional components, such as sterile disconnects or other devices. This allows a sterile boundary of the bag 12 and tubing 15 to be maintained. Multiple novel sealing methods for this passthrough are proposed below.

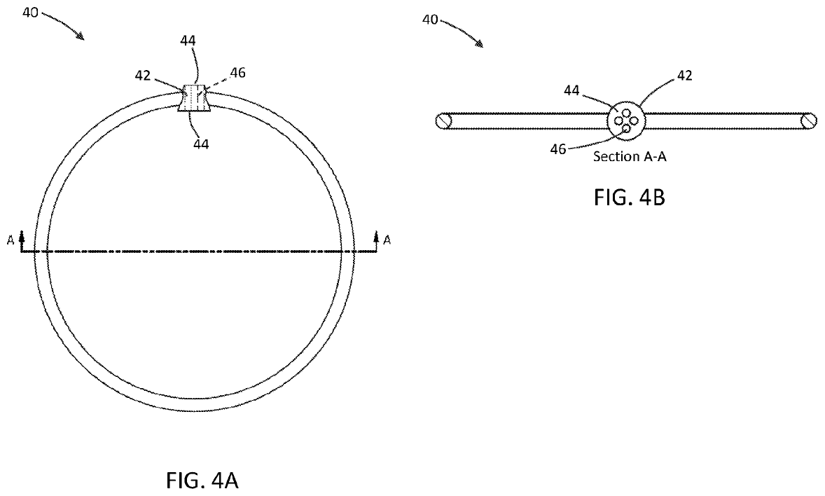

As shown in FIGS. 4A and 4B, one example of this passthrough is a custom molded gasket 40 which contains a truncated parallel conical feature 42 with the faces 44 perpendicular to the radial axis of the gasket. This gasket 40 would be fed onto the wetted fluid pathway during assembly before sterilization of the flow kit. The gasket 40 would serve to retain pressure in the external vessel and allow the wetted components to pass through apertures or fluid pathways 46 extending through the parallel faces 44 of the conical feature 42. As shown, the conical feature 42 may contain one or more fluid pathways 46.

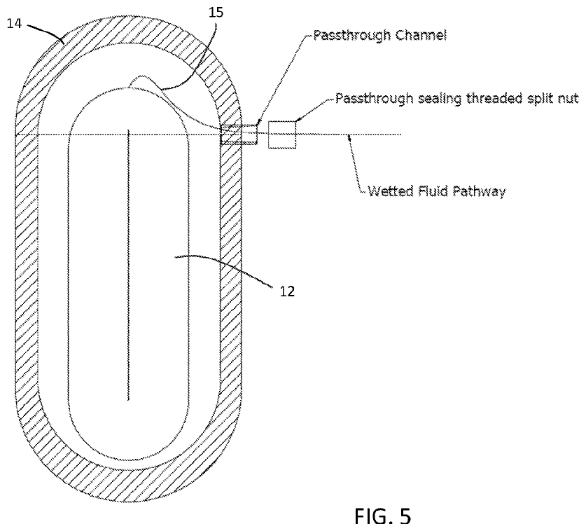

As shown in FIG. 5, the truncated conical feature would rest in a “passthrough channel” integrated into the cap and body of the pressure container 14. An external thread on this passthrough channel would allow a split bolt to be assembled around the wetted pathway, then clamped to capture and compress the internal conical feature around the wetted fluid pathway(s).

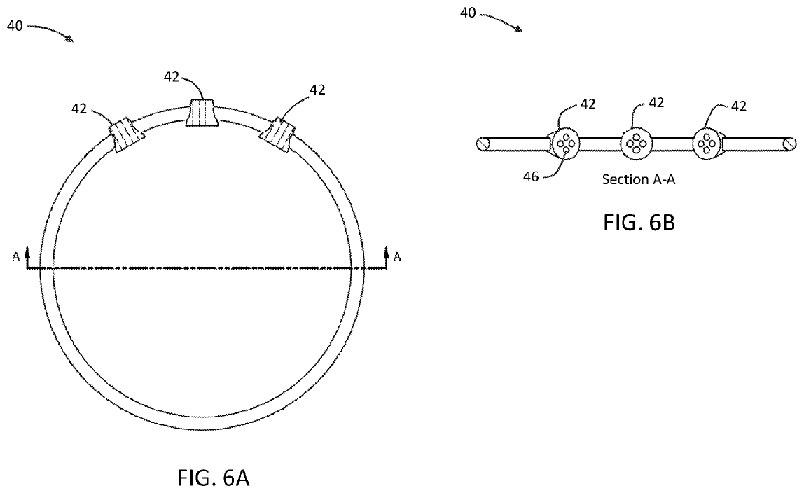

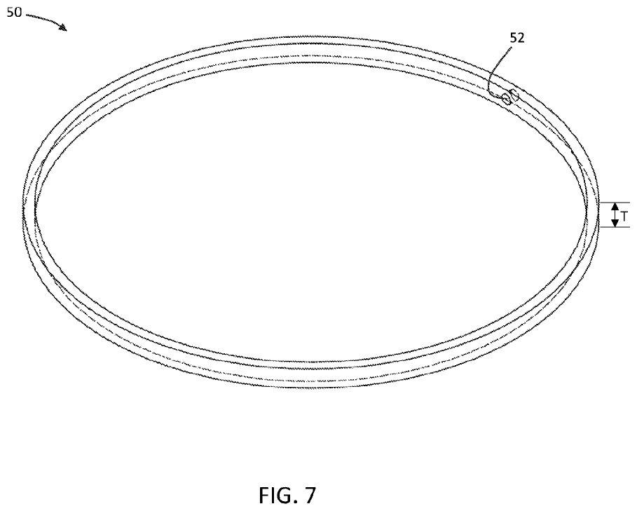

As illustrated in FIGS. 6A and 6B, gasket 40 may include multiple conical features 42 in a radial pattern around the gasket 40 with an equal number of passthrough channels built into a lid of the pressure container 14. Each of the conical features 42 may include one or more fluid pathways 46, Alternatively, as shown in FIG. 7, gasket 50 may be used. Gasket 50 utilizes a custom gasket of a thickness “T” such that T is greater in size than (e.g. 1.5-2×) the outer diameter of a fluid pathway 52 passing through the gasket 50. One or multiple pathways could be introduced into this thick gasket passthrough.

A final example of this novel passthrough utilizes another type of overmolded bulkhead feature that would allow for installation of an externally threaded feature over the wetted pathway prior to sterilization. This externally threaded feature could be allowed to move axially along the fluid pathway of the flow kit, but would interface with a bulkhead on the main body of the pressure vessel. In this example face sealing o-rings would be used to prevent pneumatic leaks around the bulkhead. This example would additionally require an internally threaded, split bolt with a face sealing o-ring to allow for clamping of the bulkhead style passthrough.

The foregoing has described a pumpless system for gradient buffer production. All of the features disclosed in this specification (including any accompanying claims, abstract and drawings), and/or all of the steps of any method or process so disclosed, may be combined in any combination, except combinations where least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. An apparatus for gradient elution, comprising:
two or more liquid flowpaths connected at a mixing point, at least one of the two or more liquid flowpaths including:
a source configured to supply a pressurized liquid;
a closed-loop flow control apparatus including a dome-loaded diaphragm valve, a flow transducer, and an electronic flow controller operably coupled to the flow transducer and the dome-loaded diaphragm valve;
a sensor configured to detect a liquid composition downstream of the mixing point; and
an electronic master controller coupled to the sensor and to the closed-loop flow control apparatus.

2. The apparatus of claim 1, wherein the source is a housing elevated above the mixing point so as to provide gravity head pressure.

3. The apparatus of claim 1, wherein the source is a housing configured to pressurize a liquid.

4. The apparatus of claim 3, wherein the housing is configured to be pressurized by a gas.

5. The apparatus of claim 4, wherein a flexible bag is disposed in the housing, and the housing is configured to introduce the pressurized gas between the flexible bag and a wall of the housing.

6. The apparatus of claim 5, wherein:
the housing includes:
a body;
a cap; and
a resilient gasket disposed between the body and the cap, the resilient gasket including a pass-through opening; and
a tube is coupled to the flexible bag and extends through the pass-through opening in the resilient gasket.

7. The apparatus of claim 1, wherein the source is a header pipe configured to carry pressurized liquid.

8. A pumpless method for gradient elution, comprising:
providing two or more flowpaths connected at a mixing point;
for each of the two or more flowpaths, flowing a liquid component down the flowpath by:
pressurizing the liquid component;
metering a flow rate of the liquid component using a closed-loop flow control apparatus including a dome-loaded diaphragm valve, a flow transducer, and an electronic flow controller operably coupled to the flow transducer and the dome-loaded diaphragm valve;
combining the liquid components at the mixing point to form a mixture;
using a sensor to evaluate a composition of the mixture; and
using an electronic master controller, receiving input from the sensor and independently controlling the closed-loop flow control apparatus of each of the two or more flowpaths so as to vary the composition of the mixture over time.

9. The method of claim 8, wherein for at least one of the two or more flowpaths, the liquid component is contained in a housing elevated above the mixing point so as to provide gravity head pressure.

10. The method of claim 8, wherein for at least one of the two or more flowpaths, the liquid component is contained in a housing that is pressurized by a gas.

11. The method of claim 10, wherein a flexible bag is disposed in the housing, and the housing the gas is introduced between the flexible bag and a wall of the housing.

12. The method of claim 11, wherein:
the housing includes:
a body;
a cap; and
a resilient gasket disposed between the body and the cap, the resilient gasket including a pass-through opening; and
a tube is coupled to the flexible bag and extends through the pass-through opening in the resilient gasket.

13. The method of claim 8, wherein for at least one of the two or more flowpaths, the liquid component is supplied from a pressurized header pipe.

14. The method of claim 13, wherein the liquid component supplied from the pressurized header pipe is WFI (water for injection).

15. The method of claim 8, wherein the composition of the mixture is changed following a profile that is linear, exponential, logarithmic, or stepwise.
